(19) United States
(12) Patent Application Publication
(10) Pub. No.: US 2009/0304087 A1
(43) Pub. Date: Dec. 10, 2009

(54) FRAME CODING AND FIELD CODING JUDGMENT METHOD, IMAGE CODING METHOD, IMAGE CODING APPARATUS, AND PROGRAM

(76) Inventors: Youji SHIBAHARA, Osaka (JP); Takahiro Nishi, Nara (JP)

Correspondence Address: WENDEROTH, LIND & PONACK L.L.P., 1030 15th Street, N.W., Suite 400 East, Washington, DC, 20005-1503, US

(21) Appl. No.: 12/477,554

(22) Filed: Jun. 3, 2009

(30) Foreign Application Priority Data
Jun. 4, 2008 (JP) 2008-146411

(51) Int. Cl. H04N 7/26

(52) U.S. Cl. 375/240.24; 375/E07.2

(57) ABSTRACT

To provide a method for increasing accuracy in judgment between frame coding and field coding without increasing the processing amount of motion compensation. The frame coding or field coding judging method includes specifying, in a reference picture, a corresponding block which corresponds to a current block to be coded, obtaining a judgment indicator based on the specified corresponding block, and judging the coding method for the current block to be coded by judging one of frame coding and field coding to be appropriate as the coding method for the current block according to the obtained judgment indicator.

### BACKGROUND OF THE INVENTION

(1) Field of the Invention

The present invention relates to a method for judging between frame coding and field coding in moving picture coding performed while switching between field coding and frame coding on a per block basis.

(2) Description of the Related Art

With a recent development of multimedia applications, various media information such as images, sounds, and text are generally handled all together. At this time, digitalization of all the media makes it possible to handle the media all together. However, since a digital image has a huge amount of data, a technique for compressing the information of the image is inevitable for accumulation and transmission of the image.

Meanwhile, standardization of compression techniques is also important for the compatible use of compressed image data. Examples of the standards on image compression techniques include H.261 and H.263 of ITU-T (International Telecommunication Union Telecommunication Standardization Sector), and MPEG- (Moving Picture Expert Group) 1, 2, and 4 of ISO/IEC (International Organization for Standardization/International Electrotechnical Commission). Another example is H.264/MPEG-4 AVC (Advanced Video Coding) standardized by JVT (Joint Video Team) which is a joint team of ITU-T and MPEG.

Generally, in moving picture coding, the amount of information is compressed by reducing redundancy in the temporal direction and in the spatial direction. Inter-predictive coding for reducing temporal redundancy includes estimating a motion on a per block basis by referring to a preceding or succeeding picture, generating a prediction image, and coding a difference value between the obtained prediction image and a current picture to be coded. Here, the term “picture” means an image plane. The picture means a frame in a progressive image, while the picture is a frame or field in an interlace image. Here, an interlace image is an image made of two temporally-different fields within a frame.

In coding processing of an interlace image, it is possible to code a frame in the frame structure, separately code the respective two fields of the frame, or code the frame while switching between the frame structure and the field structure on a per block basis within the frame (for example, see Patent Reference 1: Japanese Patent No. 2991833). Coding a frame in the frame structure is referred to as frame coding. Coding a frame in the field structure is referred to as field coding.

An I-picture is a picture which is coded using intra-predictive coding in which no reference image is required. A P-picture is a picture which is coded using inter-predictive coding in which only a single reference picture is referred to. A B-picture is a picture which is coded using inter-predictive coding in which two reference pictures are referred to at the same time. The B-picture can refer to two pictures selected, as an arbitrary combination, among pictures preceding and succeeding in display time. A reference image or a reference picture including the reference image can be specified on a per macroblock basis which is a basic unit of coding. Here, as a condition for coding these pictures, such reference picture must be coded in advance.

Inter-predictive coding with motion compensation is used for P- and B-pictures. The inter-predictive coding with motion compensation is a coding scheme in which motion compensation is applied to inter-predictive coding. Motion compensation is a scheme for estimating the amount of motion (which is referred to as a “motion vector” hereinafter) of each of units in a picture and performing prediction taking the motion vector into account with aims to increase the prediction accuracy and reduce the data amount. For example, the amount of data is reduced by estimating a motion vector in a current picture to be coded, coding a prediction residual between a prediction value obtained by a shift corresponding to the motion vector and the current picture to be coded. In the case of this scheme, information of the motion vector is required in the decoding, and thus the motion vector is also coded and either recorded or transmitted.

FIG. 19 is a structural diagram of an image coding apparatus disclosed in Patent Reference 1.

The image coding apparatus 900 is a coding apparatus which judges between field coding and frame coding for each block of a P-picture or B-picture. Such judgment between field coding and frame coding may be referred to as field or frame judgment.

The image coding apparatus 900 includes: an indicator generating unit 902, a field or frame judging unit 904, a switch 905, a coding unit 907, a decoding unit 909, a reference picture memory 910, a field-coding motion compensation unit 911, a frame-coding motion compensation unit 913, a field-coding subtracting unit 915, and frame-coding subtracting unit 916.

The indicator generating unit 902 obtains an input video signal 901 segmented into blocks, and generates a judgment indicator X indicating one of field coding and frame coding to be appropriate based on the nature of the input video signal 901.

The judgment indicator X is obtained by comparing the magnitude of a vertical adjacent pixel difference in the field structure and the magnitude of a vertical adjacent pixel difference in the frame structure. Calculation of an error which is a basis of a judgment indicator is not limited to the vertical adjacent pixel difference, and may be either a square error or the magnitudes of high-frequency components in DCT transform or Hadamard transform in the vertical direction. Here, a description is given assuming that field coding is appropriate in the case where the value of a judgment indicator is positive, but the nature of the present invention is the same even when a description is given assuming that field coding is appropriate in the case where the value of a judgment indicator is negative.

The field or frame judging unit 904 receives a judgment indicator X as an input, and controls the switch 905 in a way that field coding is selected when the value is positive, and that frame coding is selected when the value is not positive.

The switch 905 outputs the input video signal 901 to either the field-coding subtracting unit 915 or the frame-coding subtracting unit 916, based on the judgment indicator X generated by the indicator generating unit 902.

The field-coding subtracting unit 915 subtracts a video signal 912 motion compensated in field coding from the input video signal 901, and outputs a residual signal 906 which is the result of the subtraction to the coding unit 907.

The frame-coding subtracting unit 916 subtracts a video signal 914 motion compensated in frame coding from the input video signal 901, and outputs a residual signal 906 which is the result of the subtraction to the coding unit 907.

The coding unit 907 performs orthogonal transform, quantization, and variable-length coding on the residual signal 906, and outputs the resulting coded data 908. Further, the coding unit 907 outputs the coded data 908 to the decoding unit 909.

The decoding unit 909 decodes the coded data 908, and stores the decoding result which is a video signal of a reference picture in the reference picture memory 910.

The reference picture memory 910 is configured to store plural temporally-different pictures. A picture stored in the reference picture memory is referred to as a reference picture corresponding to time different from the time corresponding to the input video signal 901.

The field-coding motion compensation unit 911 refers to a reference picture stored in the reference picture memory 910, and outputs a video signal 912 motion compensated in field coding.

The frame-coding motion compensation unit 913 refers to a reference picture stored in the reference picture memory 910, and outputs a video signal 914 motion compensated in frame coding.

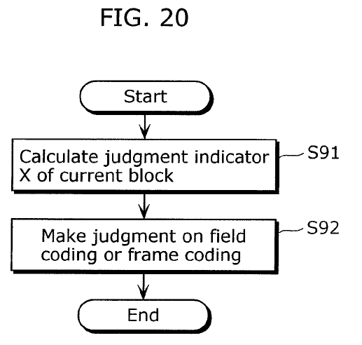

FIG. 20 is a flowchart indicating a method for judging between field coding and frame coding in the image coding apparatus disclosed in Patent Reference 1 shown in FIG. 19.

First, the indicator generating unit 902 calculates a judgment indicator X of a current block in a current frame of the input video signal (S91).

Next, the field or frame judging unit 904 determines one of field coding and frame coding to be performed, based on the judgment indicator X (S92).

### SUMMARY OF THE INVENTION

However, the image coding apparatus in the aforementioned Patent Reference 1 entails a problem of not being able to increase a compression rate due to low accuracy in the judgment between frame coding and field coding. A detailed description is given below.

One method for increasing compression efficiency is to reduce the magnitude of a residual signal 906. The residual signal 906 is a difference between the input video signal 901 and either the video signal 912 motion compensated in field coding or the video signal 914 motion compensated in frame coding. However, such judgment based on the input video signal 901 cannot yield a sufficiently small difference.

As a possible method for solving this problem is a method of activating both the field-coding motion compensation unit 911 and the frame-coding motion compensation unit 913, comparing the magnitudes of the respective residual signals 906, and selecting one of field coding and frame coding in which the smallest residual signal 906 is obtainable. However, it is general that the processing amount in motion compensation performed by the field-coding motion compensation unit 911 and the frame-coding motion compensation 913 are huge because each of the motion compensation units must apply a two-dimensional filter to the pixels in a block. Thus, activation of both the motion compensation units causes a significant increase in the processing amount of the motion compensation.

In view of the aforementioned background, the present invention aims to provide a method for increasing judgment accuracy without increasing processing amount of motion compensation in the case of judging between frame coding and field coding, for each block in a P-picture or a B-picture.

In order to solve the aforementioned problem, a frame coding and field coding judgment method according to the present invention is a method for judging between frame coding and field coding, in moving picture coding performed while switching between frame coding and field coding on a per block basis, and the method includes: (i) specifying, in a first reference picture, a first corresponding block which corresponds to a current block to be coded, the first reference picture being referred to in coding of the current block to be coded; (ii) obtaining a first judgment indicator indicating the appropriateness of frame coding or field coding for the current block to be coded, based on the first corresponding block specified in the specifying; and (iii) judging one of frame coding and field coding to be appropriate as a coding method for the current block to be coded, according to the first judgment indicator obtained in the obtaining.

With this, the judgment is made based on the block of the reference picture, it is possible to increase the judgment accuracy without increasing the processing amount of motion compensation.

In addition, in the specifying, a block co-located with the current block to be coded in a picture may be specified as the first corresponding block.

With this, it is possible to reduce the processing amount of field or frame judgment.

In addition, in the obtaining, a value indicating the amount of difference in the pixel values of pixels in the vertical direction of the first corresponding block may be obtained as the first judgment indicator.

In addition, in the obtaining, a value may be obtained as the first judgment indicator by calculation based on a first difference and a second difference, the first difference being between the pixel values of two pixels adjacent to each other in the vertical direction of the first corresponding block, and the second difference being between the pixel values of two pixels located at every other position among pixels arranged consecutively in the vertical direction of the first corresponding block; and in the judging, frame coding may be judged to be appropriate when the value which is the first judgment indicator indicates that the first difference is smaller than the second difference, the first difference being between the pixel values of the two pixels adjacent to each other in the vertical direction of the first corresponding block, and the second difference being between the pixel values of the two pixels located at every other position among pixels arranged consecutively in the vertical direction of the first corresponding block.

With this, it is possible to obtain, as specific numerical values, the judgment indicators each indicating the appropriateness of field coding or frame coding.

In addition, in the obtaining, a flag indicating whether or not an image of the first corresponding block is a still image may be obtained as the first judgment indicator, and in the judging, frame coding may be judged to be appropriate when the flag obtained in the obtaining indicates that the image is the still image.

With this, it is possible to obtain a judgment indicator indicating the appropriateness of field coding or frame coding as a flag indicating field coding or frame coding.

In addition, the method for judging between frame coding and field coding may further include obtaining a second judgment indicator indicating the appropriateness of frame coding or field coding for the current block to be coded, based on an image of the current block to be coded, and in the judging, one of frame coding and field coding may be judged to be appropriate as the coding method for the current block to be coded, according to the first judgment indicator and the second judgment indicator.

With this, a judgment is made based on both of the current block to be coded and the block of the reference picture, it is possible to increase performance in field or frame judgment.

In addition, in the obtaining of the second judgment indicator, the second judgment indicator may be obtained by performing, on the current block to be coded, the same processing as processing performed on the first corresponding block when the first judgment indicator is obtained in the obtaining of the first judgment indicator.

With this, it is possible to easily obtain judgment indicators.

In addition, the method for judging between frame coding and field coding may further include storing the second judgment indicator onto a storage area in association with the current block to be coded, the second judgment indicator being obtained based on the current block in the obtaining of the second judgment indicator, and in the specifying, the first corresponding block may be specified from among blocks associated with second judgment indicators stored respectively in the storage area, and in the obtaining of the first judgment indicator, the second judgment indicator corresponding to the first corresponding block may be obtained as the first judgment indicator from among the second judgment indicators stored in the storage area.

With this, it is possible to reduce the processing amount required to obtain the first judgment indicator.

In addition, in the judging, one of frame coding and field coding may be judged to be appropriate as the coding method for the current block to be coded, based on the result of weighted calculation of the first judgment indicator and the second judgment indicator.

With this, it is possible to make a judgment according to the preference of the judgment indicator obtainable from either the current block to be coded or the block of the reference picture.

In addition, may further include: specifying, in a second reference picture, a second corresponding block which corresponds to the current block to be coded, the second reference picture being referred to in the coding of the current block to be coded; and obtaining a third judgment indicator indicating the appropriateness of frame coding or field coding for the current block to be coded, based on the second corresponding block specified in the specifying, and in the judging, one of frame coding and field coding may be judged to be appropriate as the coding method for the current block to be coded, according to the first judgment indicator and the third judgment indicator.

With this, a judgment is made based on the judgment indicators obtained from the blocks of the two reference pictures, thereby increasing the accuracy in the field or frame judgment.

In addition, in the judging, one of frame coding and field coding may be judged to be appropriate as the coding method for the current block to be coded, based on the result of weighted calculation in which the first judgment indicator is added with a weight greater than a weight added to the third judgment indicator when the first reference picture is temporally close to a picture including the current block to be coded compared to the second reference picture.

With this, a judgment is made according to the preference of the judgment indicator obtainable from the block of the temporally-close reference picture, thereby increasing the accuracy in the field or frame judgment.

In addition, in the obtaining of the first judgment indicator, the first flag may be obtained as the first judgment indicator, the first flag indicating whether or not an image of the first corresponding block is a still image, in the obtaining of the third judgment indicator, the second flag may be obtained as the third judgment indicator, the second flag indicating whether or not an image of the second corresponding block is a still image, and in the judging, (i) frame coding may be judged to be appropriate when the first reference picture is temporally close to a picture including the current block to be coded compared to the second reference picture, and the first flag indicates that the image is the still image, and (ii) field coding may be judged to be appropriate when the first reference picture is temporally close to a picture including the current block to be coded compared to the second reference picture, and the first flag indicates that the image is not the still image.

With this, it is possible to make a judgment based on these two flags obtained from the blocks of the two reference pictures.

In addition, the method for judging between frame coding and field coding may further include obtaining a second judgment indicator indicating the appropriateness of frame coding or field coding for the current block to be coded, based on the image of the current block to be coded, and in the judging, one of frame coding and field coding may be judged to be appropriate as the coding method for the current block to be coded, according to the first judgment indicator, the second judgment indicator, and the third judgment indicator.

With this, three judgment indicators are obtained, thereby increasing the accuracy in the field or frame coding.

In addition, in the judging, when the first judgment indicator and the second judgment indicator indicate the same appropriateness, a coding method may be judged to be appropriate based on the appropriateness indicated by the first judgment indicator or the second judgment indicator and without using the third judgment indicator.

With this, it is possible to prevent frequency while switching between field coding and frame coding.

In addition, in the judging, one of frame coding and field coding may be judged to be appropriate as the coding method for the current block to be coded, based on the result of weighted calculation of the first judgment indicator, the second judgment indicator, and the third judgment indicator.

With this, it is possible to consider the preferential order of the current block to be coded and the blocks of these two reference pictures.

In addition, in the obtaining of the first judgment indicator, a numerical value may be obtained as the first judgment indicator, the numerical value indicating the magnitude of a difference obtained by calculation based on a first difference and a second difference, the first difference being between pixel values of two pixels adjacent to each other in the vertical direction of the first corresponding block, and the second difference being between the pixel values of two pixels located at every other position among pixels arranged consecutively in the vertical direction of the first corresponding block, in the obtaining of the second judgment indicator, a numerical value may be obtained as the second judgment indicator, the numerical value indicating the magnitude of a difference obtained by calculation based on a first difference and a second difference, the first difference being between the pixel values of two pixels adjacent to each other in the vertical direction of the current block to be coded, and the second difference being between the pixel values of two pixels located at every other position among pixels arranged consecutively in the vertical direction of the current block to be coded, in the obtaining of the third judgment indicator, a numerical value may be obtained as the third judgment indicator, the numerical value indicating the magnitude of a difference obtained by calculation based on a first difference and a second difference, the first difference being between the pixel values of two pixels adjacent to each other in the vertical direction of the second corresponding block, and the second difference being between the pixel values of two pixels located at every other position among pixels arranged consecutively in the vertical direction of the second corresponding block, and in the judging, frame coding may be judged to be appropriate when a numerical value for indicating the sum of the first judgment indicator, the second judgment indicator, and the third judgment indicator indicates that a first sum of differences is smaller than a second sum of differences, the first sum of differences being obtained based on the differences between the pixel values of pairs of the two pixels adjacent to each other in the vertical directions of the first corresponding block, the current block to be coded, and the second corresponding block, and the second sum of differences being obtained based on the differences between the pixel values of pairs of the two pixels located at every other position among the pixels arranged consecutively in the vertical directions of the first corresponding block, the current block to be coded, and the second corresponding block.

With this, it is possible to make a judgment by performing simple processing of summing these judgment indicators.

In addition, the present invention may be implemented as a method which is intended to code an image while switching between frame coding and field coding on a per block basis and includes the method for judging between frame coding and field coding.

With this, it is possible to use the method as the image coding method which enables achievement of a high accuracy in judgment between frame coding and field coding.

In addition, the present invention may be implemented as an image coding apparatus which performs coding while switching between frame coding and field coding on a per block basis, and includes: a first corresponding block specifying unit configured to specify, in a first reference picture, a first corresponding block which corresponds to a current block to be coded, the first reference picture being referred to in coding of the current block to be coded; a first judgment indicator obtaining unit configured to obtain a first judgment indicator indicating the appropriateness of frame coding or field coding for the current block to be coded, based on the first corresponding block specified by the first corresponding block specifying unit; and a judging unit configured to judge one of frame coding and field coding to be appropriate as a coding method for the current block to be coded, according to the first judgment indicator obtained by the first judgment indicator obtaining unit.

With this, it is possible to use the image coding method which enables achievement of high accuracy in judgment between frame coding and field coding.

In addition, the present invention may be implemented as a program causing a computer to execute the method for judging between frame coding and field coding.

With this, it is possible to provide, as a program, the method for judging between frame coding and field coding.

According to the present invention, it is possible to increase accuracy in judgment between frame coding and field coding made for each block of a P-picture and B-picture without increasing the processing amount of motion compensation.

### FURTHER INFORMATION ABOUT TECHNICAL BACKGROUND TO THIS APPLICATION

The disclosure of Japanese Patent Application No. 2008-146411 filed on Jun. 4, 2008 including specification, drawings and claims is incorporated herein by reference in its entirety.

### BRIEF DESCRIPTION OF THE DRAWINGS

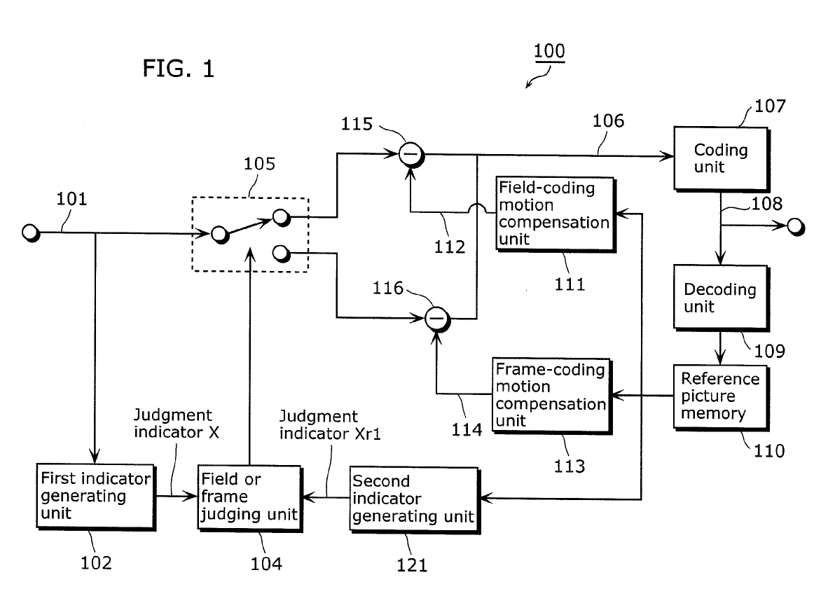

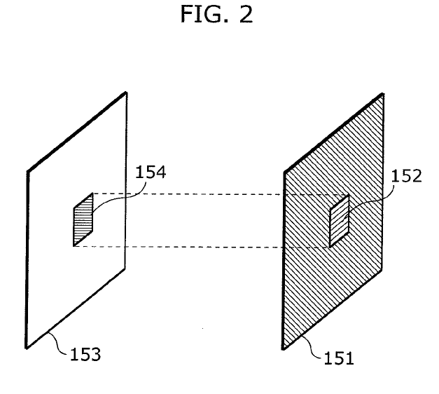

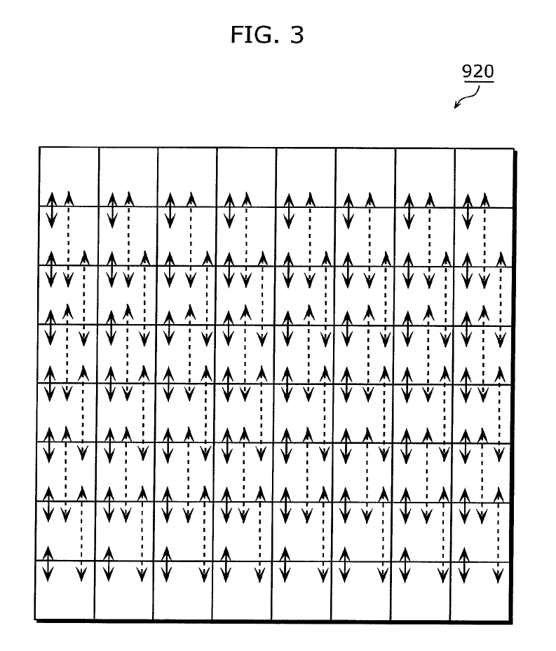

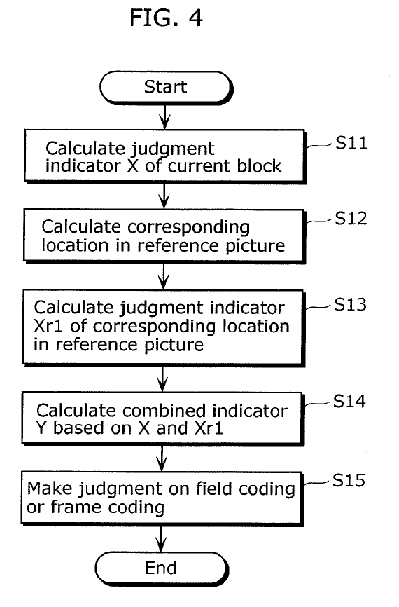

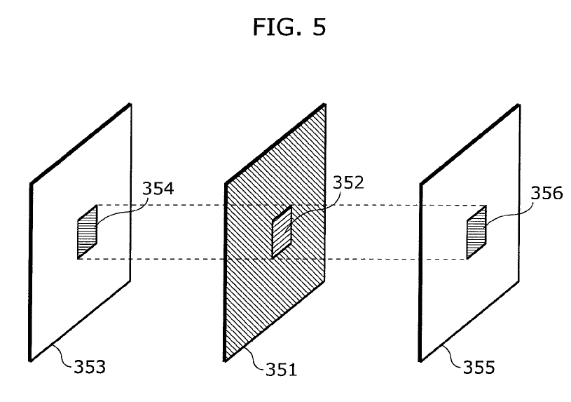

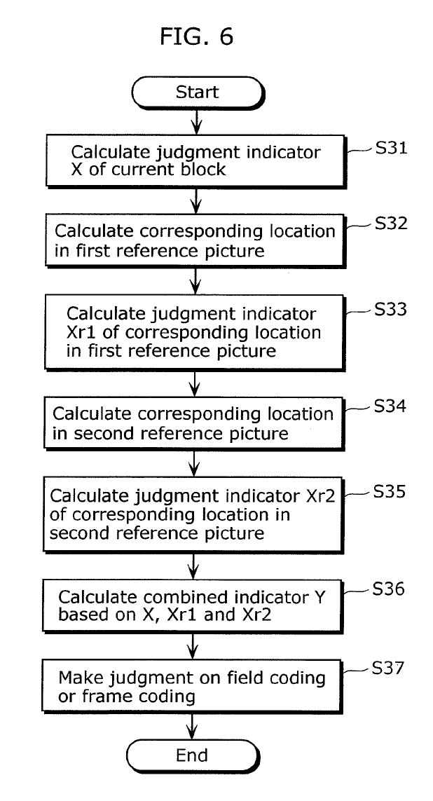

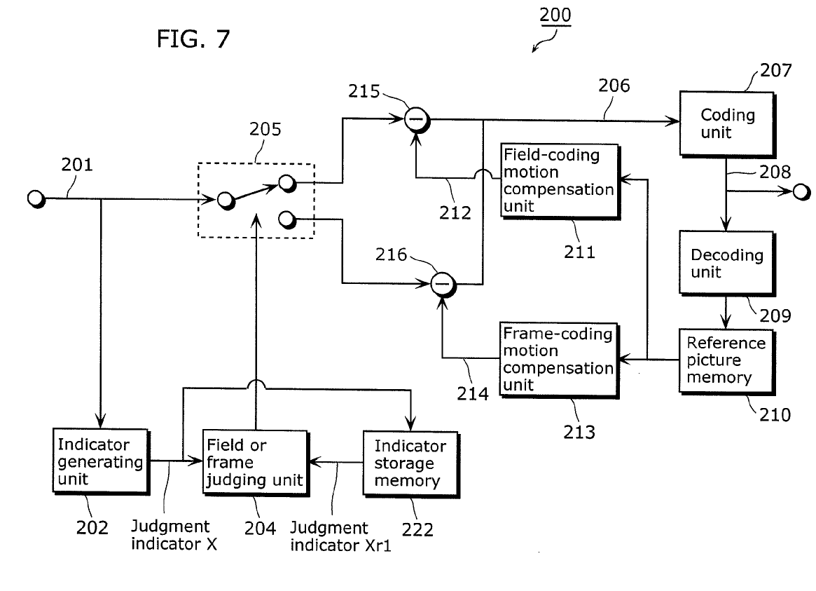

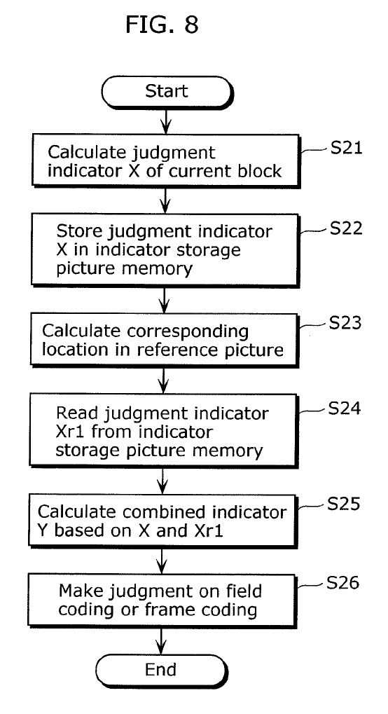

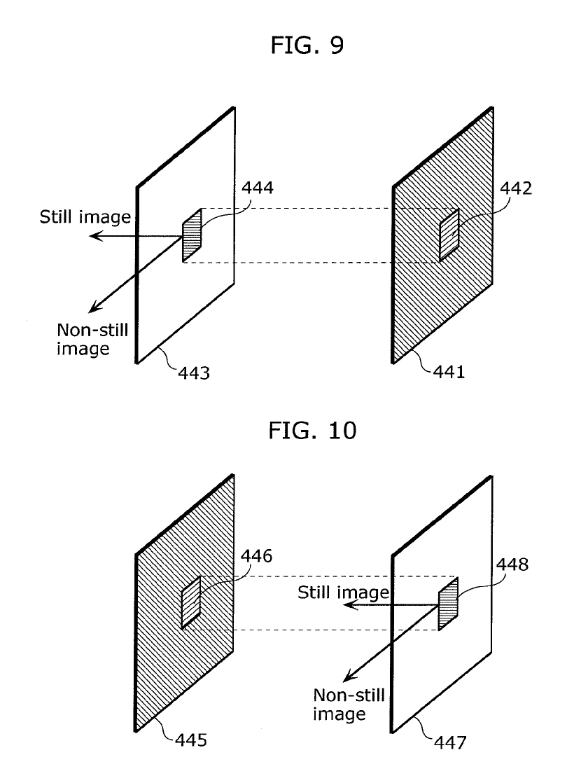

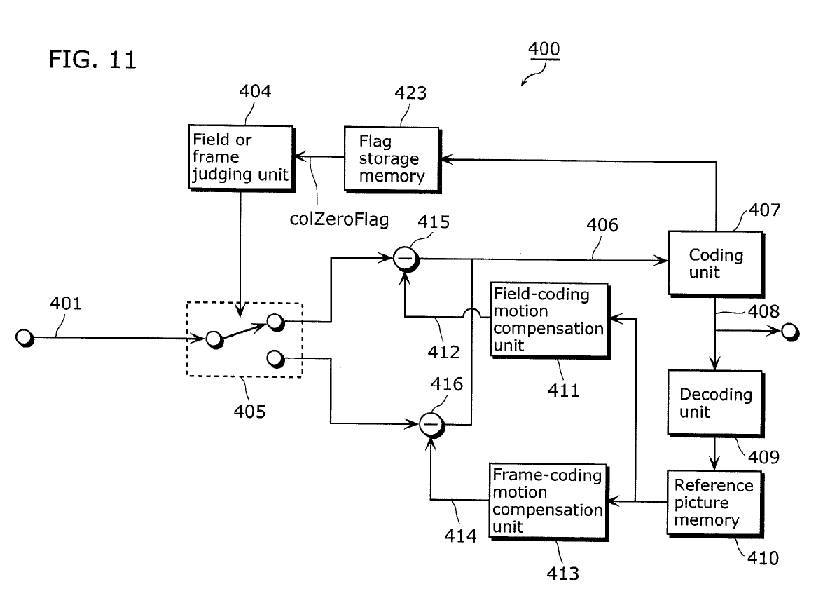

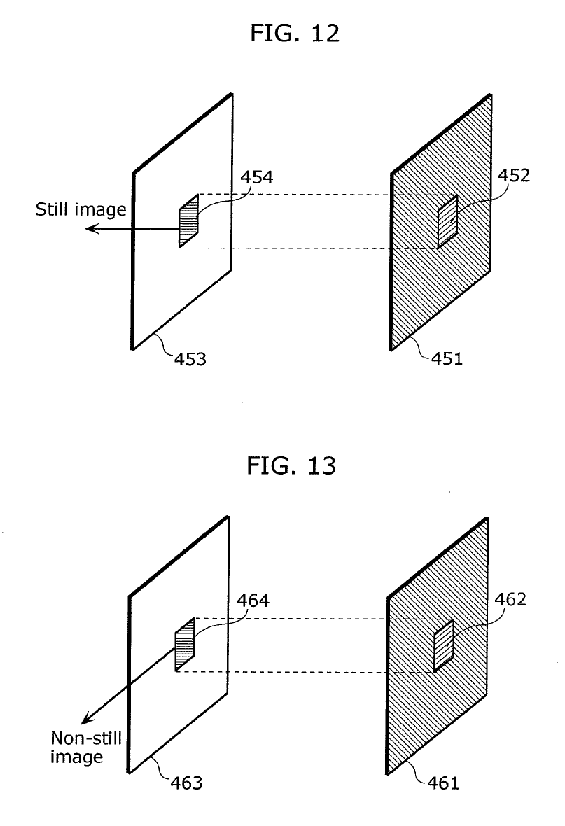

These and other objects, advantages and features of the invention will become apparent from the following description thereof taken in conjunction with the accompanying drawings that illustrate a specific embodiment of the invention. In the Drawings:

[FIG. 1] FIG. 1 is a structural diagram of an image coding apparatus in Embodiment 1;

[FIG. 2] FIG. 2 is a conceptual diagram showing the relationship between a block of a P-picture and a judgment indicator in Embodiment 1;

[FIG. 3] FIG. 3 is a conceptual diagram illustrating a generating process of judgment indicators in Embodiment 1;

[FIG. 4] FIG. 4 is a flowchart showing a method for judging one of field coding and frame coding to be performed on a P-picture on a per block basis in Embodiment 1;

[FIG. 5] FIG. 5 is a conceptual diagram showing the relationship between a block of a B-picture and judgment indicators in Embodiment 1;

[FIG. 6] FIG. 6 is a flowchart showing a method for judging one of field coding and frame coding to be performed on a B-picture on a per block basis in Embodiment 1;

[FIG. 7] FIG. 7 is a structural diagram of an image coding apparatus in Embodiment 2;

[FIG. 8] FIG. 8 is a flowchart indicating a method for judging one of field coding and frame coding to be performed on a B-picture on a per block basis in Embodiment 2;

[FIG. 9] FIG. 9 is a diagram illustrating colZeroFlag in a reference picture preceding in display order;

[FIG. 10] FIG. 10 is a diagram illustrating colZeroFlag in a reference picture succeeding in display order;

[FIG. 11] FIG. 11 is a structural diagram of an image coding apparatus in Embodiment 3;

[FIG. 12] FIG. 12 is a conceptual diagram showing a judgment method in the case where the value of colZeroFlag indicates a still image in Embodiment 3;

[FIG. 13] FIG. 13 is a conceptual diagram showing a judgment method in the case where the value of colZeroFlag indicates a non-still image in Embodiment 3;

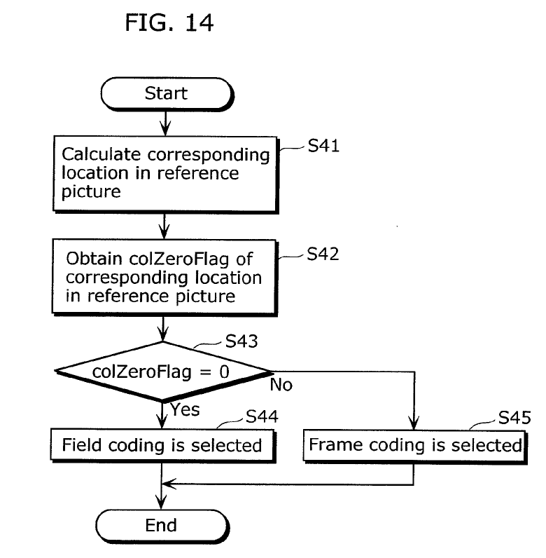

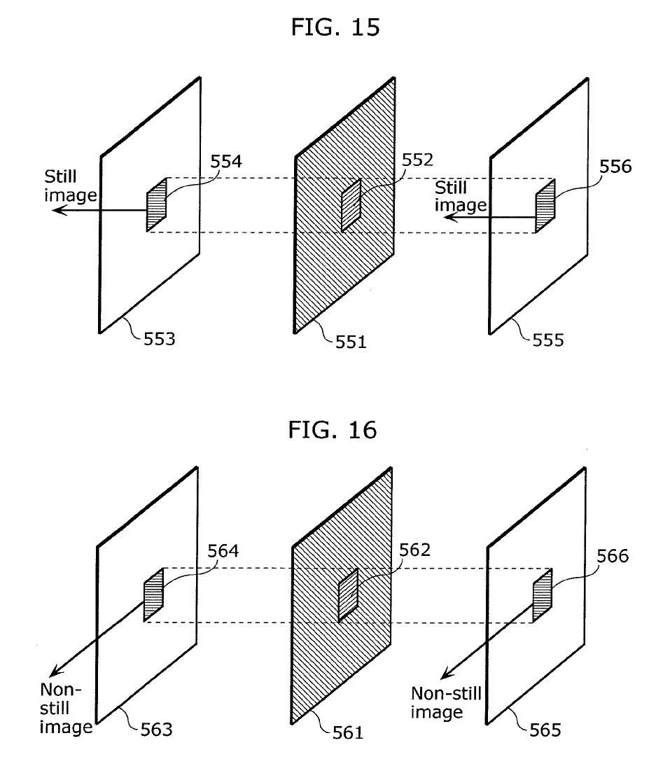

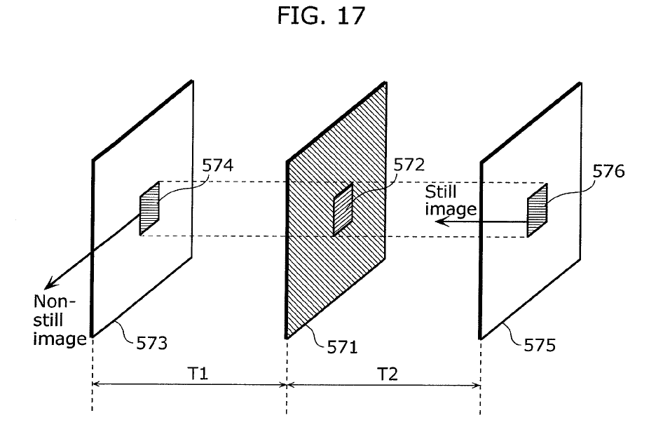

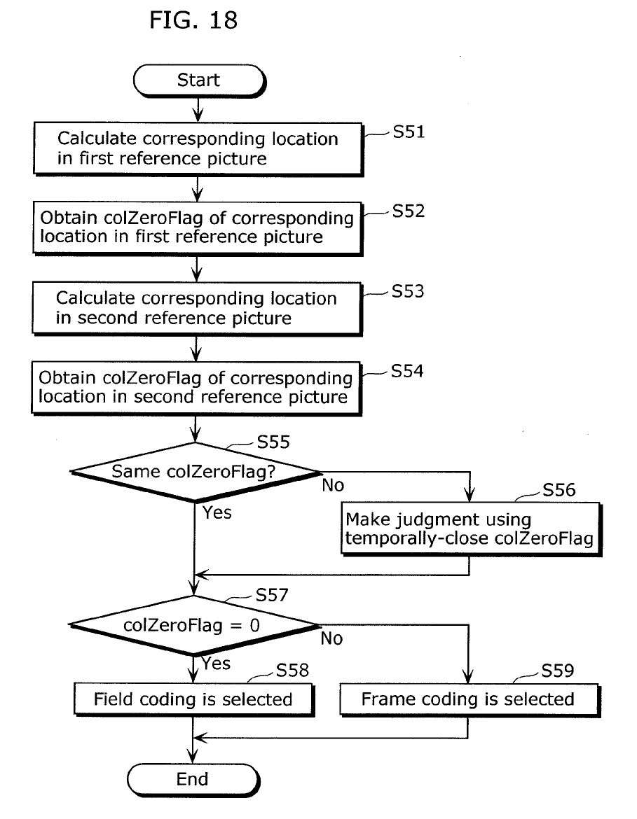

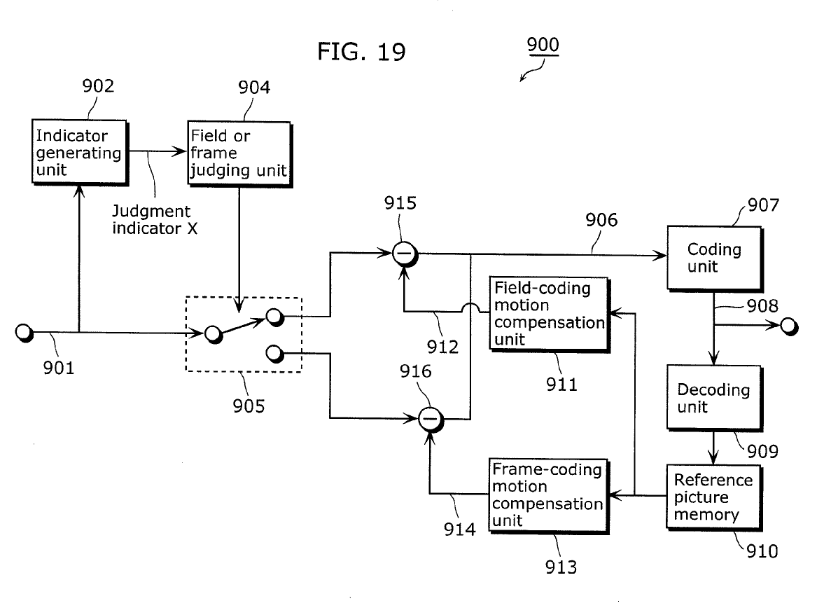

8 FIG. 14] FIG. 14 is a flowchart indicating a method for judging one of field coding and frame coding to be performed on a P-picture on a per block basis in Embodiment 3;

[FIG. 15] FIG. 15 is a conceptual diagram showing a judgment method in the case where each of two values of colZeroFlag indicates a still image in Embodiment 3;

[FIG. 16] FIG. 16 is a conceptual diagram showing a judgment method in the case where each of two values of colZeroFlag indicates a non-still image in Embodiment 3;

[FIG. 17] FIG. 17 is a conceptual diagram showing a judgment method in the case where two values of colZeroFlag indicates a still image and a non-still image respectively in Embodiment 3;

[FIG. 18] FIG. 18 is a flowchart indicating a method for judging one of field coding and frame coding to be performed on a B-picture on a per block basis in Embodiment 3;

[FIG. 19] FIG. 19 is a structural diagram of an image coding apparatus disclosed in Patent Reference 1; and

[FIG. 20] FIG. 20 is a flowchart indicating a method for judging one of field coding and frame coding to be performed in the image coding apparatus disclosed in Patent Reference 1.

### DESCRIPTION OF THE PREFERRED EMBODIMENTS

### Embodiment 1

First, Embodiment 1 of the present invention is described with reference to the drawings.

FIG. 1 is a structural diagram of an image coding apparatus in Embodiment 1.

An image coding apparatus 100 is an image coding apparatus which judges between frame coding and field coding on a per block basis. Here, an exemplary picture is assumed to be a P-picture.

The image coding apparatus 100 is implemented as an electric circuit embedded in hardware, and includes: a first indicator generating unit 102, a field or frame judging unit 104, a switch 105, a coding unit 107, a decoding unit 109, a reference picture memory 110, a field-coding motion compensation unit 111, a frame-coding motion compensation unit 113, a field-coding subtracting unit 115, a frame-coding subtracting unit 116, and a second indicator generating unit 121.

The first indicator generating unit 102 obtains an input video signal 101 segmented into blocks, and generates a judgment indicator X indicating one of field coding and frame coding to be performed, based on the nature of the input video signal 101.

The second indicator generating unit 121 generates a judgment indicator Xr1 from information different from information obtained from the input video signal 101. Here, the second indicator generating unit 121 cannot use a video signal 112 obtainable through field coding with motion compensation and video signal 114 obtainable through frame coding with motion compensation because two-dimensional filtering performed therein on a per pixel basis leads to a significant increase in the processing amount For this reason, the second indicator generating unit 121 generates the judgment indicator Xr1 indicating the appropriateness of frame coding or field coding based on the video signal of a corresponding block in a reference picture with reference to the reference picture memory 110, and notifies the judgment indicator Xr1 to the field or frame judging unit 104.

The field or frame judging unit 104 specifies the corresponding block, and notifies it to the second indicator generating unit 121. The corresponding block is, for example, a block in the reference picture which is or is deemed to be similar to a current block. In addition, in order to obtain the position of the corresponding block within a picture, the field or frame judging unit 104 may estimate the position of the corresponding block within integer accuracy positions for which filtering is unnecessary, based on the result of motion compensation performed on a previous picture, or may estimate the position of the corresponding block within integer accuracy positions for which filtering is unnecessary, based on the result of motion compensation performed on a peripheral block. Otherwise, in order to further reduce the processing amount, the position of a corresponding block may be determined based on the position of a current block.

The field or frame judging unit 104 further makes a judgment using a new indicator Y which is obtained by a combination of the judgment indictor X of the current block and the judgment indicator Xr1 of the corresponding block of the reference picture. For example, the field or frame judging unit 104 makes a judgment based on Y obtained according to Expression 1 where the value indicated by the judgment indicator X is X, the value indicated by the judgment indicator Xr1 is Xr1, and the value indicated by the new indicator Y is Y.

Y=X+K*Xr1 (Expression 1)

For example, K in Expression 1 is a predetermined constant and a numerical value as a weight added to Xr1. In other words, K in Expression 1 indicates a ratio by which the judgment indicator Xr1 obtained from the corresponding block is considered.

Assuming that field coding is appropriate when the values indicated by the judgment indicator X and the judgment indicator Xr1 are positive, the field or frame judging unit 104 judges that field coding is performed when the value of the indicator Y is positive, and judges that frame coding is performed when the value of the indicator Y is not positive.

It is to be noted that, in Embodiment 1, the field or frame judging unit 104 includes: a corresponding block specifying unit which specifies a corresponding block, a judgment indicator obtaining unit which obtains a judgment indicator based on the block, and a judging unit which judges one of frame coding and field coding to be performed based on the judgment indicator.

The switch 105 outputs the input video signal 101 to either the frame-coding subtracting unit 115 or the frame-coding subtracting unit 116, based on the judgment indicator X generated by the first indicator generating unit 102.

The field-coding subtracting unit 115 subtracts a video signal 112 motion compensated in field coding from the input video signal 101, and outputs a residual signal 106 which is the result of the subtraction to the coding unit 107.

The frame-coding subtracting unit 116 subtracts a video signal 114 motion compensated in frame coding from the input video signal 101, and outputs a residual signal 106 which is the result of the subtraction to the coding unit 107.

The coding unit 107 performs orthogonal transform, quantization, and variable-length coding on the residual signal 106, and outputs the resulting coded data 108. Further, the coding unit 107 outputs the coded data 108 to the decoding unit 109.

The decoding unit 109 decodes the coded data 108, and stores the decoding result which is a video signal of a reference picture into a reference picture memory 110.

The reference picture memory 110 is configured to store plural temporally-different pictures. A picture stored in the reference picture memory is referred to as a reference picture corresponding to time different from the time corresponding to the input video signal 101.

The field-coding motion compensation unit 111 performs motion compensation with reference to a reference picture stored in the reference picture memory, and outputs the video signal 112 motion-compensated in field coding.

The frame-coding motion compensation unit 113 performs motion compensation with reference to a reference picture stored in the reference picture memory, and outputs the video signal 114 motion-compensated in frame coding.

With this judgment method, it is unnecessary to activate both the field-coding motion compensation unit 111 and the frame-coding motion compensation unit 113 which require great amount of processing for judging one of field coding and frame coding to be performed on a per block basis. This judgment is made using the input video signal 101 and a video signal of the reference picture based on which a residual signal 106 is generated, which increases the judgment accuracy. Accordingly, it becomes possible to reduce the magnitude of the residual signal 106, thereby increasing the compression rate.

This advantageous effect is remarkable especially in a situation where an image content in a current block is not clearly shown, the value indicated by the judgment indicator X in the current block is not a large value, and it is difficult to judge one of filed coding and frame coding to be performed. Even in this situation, on condition that the appropriateness of either field coding or frame coding is clearly shown by a reference picture, it is possible to increase the judgment accuracy using the indicator Y defined according to Expression 1 because the value indicated by the judgment indicator Xr1 of the reference picture shows a large value.

It is to be note that the judgment indicator X and the judgment indicator Xr1 are obtained by comparing the magnitude of a vertical adjacent pixel difference in field structure, and the magnitude of a vertical adjacent pixel difference in frame structure. Calculation of an error which is a basis of a judgment indicator is not limited to the vertical adjacent pixel difference, and may be either a square error or the magnitudes of high-frequency components in DCT transform or Hadamard transform in the vertical direction. The aforementioned description is given assuming that field coding is appropriate when the judgment indicator X and the judgment indicator Xr1 are positive. However, the nature of the present invention is the same even when a description is given assuming that field coding is appropriate when the judgment indicator X and the judgment indicator Xr1 are-negative.

FIG. 2 is a conceptual diagram showing the relationship between a block in a P-picture in Embodiment 1 shown in FIG. 1 and a judgment indicator.

A current frame 151 is an image corresponding to the input video signal 101 and a current image to be coded.

The current block 152 is a block included in a current frame 151, and is a current block to be coded. The first indicator generating unit 102 calculates a judgment indicator X from the image in the current block 152.

The reference picture 153 is a picture to be referred to in the coding of the current frame 151.

The corresponding block 154 is a block included in the reference picture 153, and is a block corresponding to the current block 152 which is the current block to be coded. The second indicator generating unit 121 calculates a judgment indicator Xr1 from the corresponding block 154.

FIG. 3 is a conceptual diagram illustrating an exemplary processing for generating judgment indicators in Embodiment 1 shown in FIG. 1.

The block 920 is the current block to be coded corresponding to the input video signal. A judgment indicator indicating the appropriateness of field coding or frame coding is, for example, a result obtainable by comparing the difference in the pixel values of two pixels shown by solid arrows in FIG. 3 and the difference in the pixel values of two pixels shown in broken arrows in FIG. 3. As for the comparison of the difference obtained for respective pairs of pixels, it is also good to compare the total sum of the absolute values of the differences between the respective pairs of pixels, or to compare the average of the absolute values of the differences between the respective pairs of pixels. In addition, it is also good to compare the square total sum of the differences between the respective pairs of pixels, or to compare the square average of the differences between the respective pairs of pixels.

The value of the judgment indicator indicates that field coding is more appropriate according to the degree of difference by which the difference between the pixel values of the pair of pixels shown by the solid arrows is greater than the difference between the pixel values of the pair of pixels shown by the broken arrows. On the other hand, the value of the judgment indicator indicates that frame coding is more appropriate according to the degree of difference by which the difference between the pixel values of the pair of pixels shown by the solid arrows is smaller than the difference between the pixel values of the pair of pixels shown by the broken arrows.

It is to be noted that, in an interlace image, the pair of pixels shown by the solid arrows is images in temporally different fields, and the pair of pixels shown by broken arrows is images in temporally same fields. Thus, in a moving picture, it is likely that the difference between the pixel values of the pair of pixels shown by the solid arrows is great, and, in a still image, it is likely that the difference between the pixel values of the pair of pixels shown by the solid arrows is relatively small because the pair of pixels are spatially close to each other.

FIG. 4 is a flowchart indicating a method for judging one of field coding and frame coding to be performed on a P-picture on a per block basis in Embodiment 1 shown in FIG. 1.

First, the first indicator generating unit 102 calculates a judgment indicator X of the current block of the current frame of the input video signal (S11).

Next, the field or frame judging unit 104 determines a block at the corresponding position in the reference picture (S12).In the case of calculating a corresponding position in the reference picture, it is good to calculate the position based on the result of motion compensation performed on a peripheral block, to estimate (perform motion estimation on) the position of the block which has the highest degree of similarity, or to calculate it based on either the motion compensation or motion estimation of the picture preceding in display order. Otherwise, it is also good to simply determine a co-located block in a picture to be the block at the same position. For simplicity, it is also good to limit to integer accuracy.

Next, the second indicator generating unit 121 calculates the judgment indicator Xr1 of the block at the corresponding position of the reference picture (S13).

Next, the field or frame judging unit 104 calculates a new indicator Y from a combination of the judgment indicator X and the judgment indicator Xr1 (S14).

Next, the field or frame judging unit 104 determines, based on the indicator Y, whether coding is performed in field structure or frame structure (S15).

The above-described description has been given of field coding and frame coding performed on a P-picture on a per block basis, but the same coding may be performed on a B-picture. In the case of a B-picture, the structure of the image coding apparatus 100 in Embodiment 1 shown in FIG. 1 also enables obtainment of a judgment indicator from a corresponding block. Since a B-picture refers to two reference pictures, the second indicator generating unit 121 generates the judgment indicator Xr1 and the judgment indicator Xr2 each indicating appropriateness of field coding or frame coding, based on the corresponding blocks of the respective reference pictures.

FIG. 5 is a conceptual diagram showing the relationship between a block in a B-picture and a judgment indicator in Embodiment 1.

A current frame 351 is an image corresponding to the input video signal 101 and a current image to be coded.

The current block 352 is a block included in the current frame 351, and is a current block to be coded. The first indicator generating unit 102 calculates a judgment indicator X from the image in the current block 352.

The first reference picture 353 is a first reference picture referred to in coding of the current frame 351.

The first corresponding block 354 is a block which is included in the first reference picture 353, and corresponds to the current block 352 which is a current block to be coded. The second indicator generating unit 121 calculates a judgment indicator Xr1 from the image in the first corresponding block 354.

The second reference picture 355 is a second picture referred to in coding of the current frame 351.

The second corresponding block 356 is a block which is included in the second reference picture 355, and corresponds to the current block 352 which is the current block to be coded. The second indicator generating unit 121 calculates a judgment indicator Xr2 from the image in the second corresponding block 356.

For example, the field or frame judging unit 104 judges one of field coding and frame coding to be performed, based on the indicator Y obtainable according to Expression 2 where the value indicated by the judgment indicator X is X, the value indicated by the judgment indicator Xr1 is Xr1, the value indicated by the judgment indicator Xr2 is Xr2, and the value indicated by the new indicator Y is Y.

Y=X+K1*Xr1+K2*Xr2 (Expression 2)

For example, K1 and K2 in Expression 2 are predetermined constants, and numerical values which are weights added to Xr1 and Xr2, respectively. In other words, K1 and K2 in Expression 2 indicate a ratio by which the judgment indicator Xr1 and the judgment indicator Xr2 obtained by the respectively corresponding blocks are considered.

When it is assumed that field coding is appropriate when the values indicated by the judgment indicator X, the judgment indicator Xr1, and the judgment indicator Xr2 are positive, the field or frame judging unit 104 judges that field coding is performed when the value of the indicator Y is positive, and that frame coding is performed when the value of the indicator Y is not positive.

In the case of judging between field coding and frame coding at a co-location, not frequently switching in the temporal direction may be subjectively stable and make a good impression. In view of this advantageous effect, in the case where the judgment indicator Xr1 and the judgment indicator Xr2 indicate the same appropriateness, the field or frame judging unit 104 may make a judgment without reference to the judgment indicator X. In other words, when it is assumed that field coding is appropriate when the values indicated by the judgment indicator X, the judgment indicator Xr1, and the judgment indicator Xr2 are positive, the field or frame judging unit 104 may judge between field coding or frame coding without reference to the judgment indicator X of the current block when the values of the judgment indicator Xr1 and the judgment indicator Xr2 have the same codes.

FIG. 6 is a flowchart showing a method for judging one of field coding and frame coding to be performed on a B-picture on a per block basis in Embodiment 1.

First, the first indicator generating unit 102 calculates a judgment indicator X of the current block of the current frame in the input video signal (S31).

Next, the field or frame judging unit 104 calculates the position of the corresponding block of the first reference picture (S32).

Next, the second indicator generating unit 121 calculates the judgment indicator Xr1 for the position of the corresponding block of the first reference picture (S33).

Next, the field or frame judging unit 104 calculates the position of the corresponding block of the second reference picture (S34).

Next, the second indicator generating unit 121 calculates the judgment indicator Xr2 for the position of the corresponding block of the second reference picture (S35).

Next, the field or frame judging unit 104 calculates the indicator Y as a combination from the judgment indicator X, the judgment indicator Xr1, and the judgment indicator Xr2 (S36).

Next, the field or frame judging unit 104 determines one of field coding and frame coding to be performed, based on the indicator Y (S37).

### Embodiment 2

FIG. 7 is a structural diagram of an image coding apparatus in Embodiment 2.

An image coding apparatus 200 is an image coding apparatus which judges one of frame coding and field coding to be performed on a per block basis. The difference from Embodiment 1 lies in that the second indicator generating unit 121 is replaced with an indicator storage memory 222. This enables reduction in the frequency of reading a video signal from the reference picture memory 110.

An indicator generating unit 202 stores the generated judgment indicator X in the indicator storage memory 222 on a per block basis. The indicator storage memory 222 is configured to store judgment indicators regarding temporally different pictures, and operate as a time manager in the same manner as the reference picture memory.

A field or frame judging unit 204 obtains the judgment indicator X from the indicator generating unit 202, obtains the judgment indicator Xr1 from the indicator storage memory 222, and makes a field or frame judgment based on a combination of the judgment indicator X and the judgment indicator Xr1.

It is to be noted that a switch 205, a coding unit 207, a decoding unit 209, a reference picture memory 210, a field-coding motion compensation unit 211, a frame-coding motion compensation unit 213, a field-coding subtracting unit 215, and a frame-coding subtracting unit 216 operate in the same manner as the switch 105, the coding unit 107, the decoding unit 109, the reference picture memory 110, the field-coding motion compensation unit 111, the frame-coding motion compensation unit 113, the field-coding subtracting unit 115, and the frame-coding subtracting unit 116 in Embodiment 1 shown in FIG. 1.

FIG. 8 is a flowchart indicating a method for judging one of field coding and frame coding to be performed on a P-picture on a per block basis in Embodiment 2 shown in FIG. 7.

First, the indicator generating unit 202 calculates a judgment indicator X of a current block in a current frame of the input video signal (S21).

Next, the indicator generating unit 202 stores the judgment indicator X in the indicator storage memory 222 in association with the position of a current block of a current frame (S22).

Next, the field or frame judging unit 204 determines a block at the corresponding position in the reference picture (S23). This is the same as in the process (S12) shown in FIG. 4 in Embodiment 1.

Next, the field or frame judging unit 204 reads, from the indicator storage memory 222, the judgment indicator Xr1 associated with the position of the corresponding block of the reference picture (S24).

Next, the field or frame judging unit 204 calculates an indicator Y as a combination from the judgment indicator X and the judgment indicator Xr1 (S25).This is the same as in the process (S14) shown in FIG. 4 in Embodiment 1.

Next, the field or frame judging unit 204 determines, based on the indicator Y, one of field structure and frame structure to be selected for coding (S26). This is the same as in the process (S15) shown in FIG. 4 in Embodiment 1.

It is to be noted that the same judgment can be made on a B-picture. In other words, the field or frame judging unit 204 may make a judgment according to a judgment method similar to the judgment method in Embodiment 1 by obtaining the judgment indicator Xr2 of the corresponding block in the second reference picture from the indicator storage memory 222 and using the judgment indicator X, the judgment indicator Xr1, and the judgment indicator Xr2.

### Embodiment 3

An image coding apparatus in Embodiment 3 is an image coding apparatus which uses, as a judgment indicator, colZeroFlag generated when an image is coded.

Here, colZeroFlag is essential information defined for each block of a P-picture in the standard H.264/MPEG-4 AVC, and indicates presence/absence of a motion in the image of the block. The image coding apparatus in Embodiment 3 eliminates the necessity of performing any special calculation processing for obtaining a judgment indicator by using colZeroFlag as the judgment indicator.

FIG. 9 is a diagram illustrating colZeroFlag in a reference picture preceding in display order.

A current frame 441 is a P-picture or a B-picture, and is coded using the reference picture 443.

The current block 442 is a block coded at this time point.

A reference picture 443 is a P-picture, and is a picture referred to when the current frame 441 is coded.

The corresponding block 444 is a block included in the reference picture 443, and is a block corresponding to the current block 442.The position of the corresponding block 444 in the picture is determined as in the method specified in Embodiment 1. For example, the corresponding block 444 is a block located at the same position as that of the current block 442 in the current frame 441.

When the corresponding block 444 of the reference picture 443 is coded based on the standard H.264/MPEG-4 AVC, colZeroFlag is defined for the corresponding block 444. When the image of the corresponding block 444 is a still image, the value of colZeroFlag is 1. When the image of the corresponding block 444 is a moving image, the value of colZeroFlag is 0.

FIG. 10 is a diagram illustrating colZeroFlag in a reference picture succeeding in display order.

The current frame 445 is a B-picture, and is coded using the reference picture 447.

The current block 446 is a block coded at this time point.

A reference picture 447 is a P-picture, and is a picture referred to when the current frame 445 is coded.

The corresponding block 448 is a block in the reference picture 447, and is a block corresponding to the current block 446.The position of the corresponding block 448 in the picture is determined as in the method specified in Embodiment 1. For example, the corresponding block 448 is a block located at the same position as that of the current block 446 in the current frame 445.

When the corresponding block 448 of the reference picture 447 is coded, colZeroFlag is also defined for the corresponding block 448.When the image of the corresponding block 448 is a still image, the value of colZeroFlag is 1. When the image of the corresponding block 448 is a moving image, the value of colZeroFlag is 0.

FIG. 11 is a structural diagram of an image coding apparatus in Embodiment 3.

An image coding apparatus 400 is an image coding apparatus which judges one of frame coding and field coding to be performed on a per block basis.

The image coding apparatus 400 includes: a field or frame judging unit 404, a switch 405, a coding unit 407, a decoding unit 409, a reference picture memory 410, a field-coding motion compensation unit 411, a frame-coding motion compensation unit 413, a field-coding subtracting unit 415, a frame-coding subtracting unit 416, and a flag storage memory 423.

Compared to the image coding apparatus 100 in Embodiment 2, the flag storage memory 423 is added. In addition, compared to the field or frame judging unit 104 in Embodiment 1, the operation of the field or frame judging unit 404 is modified. Further, compared to the coding unit 107 in Embodiment 1, the operation of the coding unit 407 is modified. The first indicator generating unit 102 in Embodiment 1 is not required in Embodiment 3.

The coding unit 407 defines colZeroFlag for each block, and stores colZeroFlag in the flag storage memory 423 in association with the block.

The flag storage memory 423 is configured to store the value of colZeroFlag for each block.

The field or frame judging unit 404 obtains colZeroFlag defined for the corresponding block from the flag storage memory 423, and judges between field coding and frame coding.

It is to be noted that a switch 405, a decoding unit 409, a reference picture memory 410, a field-coding motion compensation unit 411, a frame-coding motion compensation unit 413, and a filed-coding subtracting unit 415, a frame-coding subtracting unit 416 operate in the same manner as the a switch 105, a decoding unit 109, a reference picture memory 110, a field-coding motion compensation unit 111, a frame-coding motion compensation unit 113, and a filed-coding subtracting unit 115, a frame-coding subtracting unit 116 in Embodiment 1 shown in FIG. 1.

FIG. 12 is a conceptual diagram showing a judgment method in the case where the value of colZeroFlag in Embodiment 3 shown in-FIG. 11 indicates a “still image”.

A current frame 451 is an image corresponding to the input video signal 401, and is a current image to be coded.

The current block 452 is a block included in the current frame 451, and is a current block to be coded.

The reference picture 453 is a picture to be referred to in the coding of the current frame 451.

The corresponding block 454 is a block included in the reference picture 453, and is a block corresponding to the current block 452 which is the current block to be coded. In the corresponding block 454 shown in FIG. 12, the value of colZerlFlag indicates a “still image”. In this case, the value of colZerIFlag is 1 which is a value of a judgment indicator indicating a tendency of coding a current block 452 using frame coding. Accordingly, the field or frame judging unit 404 judges that frame coding is performed.

FIG. 13 is a conceptual diagram showing a judgment method in the case where the value of colZeroFlag in Embodiment 3 shown in FIG. 11 indicates a “non-still image”.

A current frame 461 is an image corresponding to the input video signal 401, and is a current image to be coded.

The current block 462 is a block included in the current frame 461, and is a current block to be coded.

The reference picture 463 is a picture to be referred to in the coding of the current frame 461.

The corresponding block 464 is a block included in the reference picture 463, and is a block corresponding to the current block 462 which is the current block to be coded. In the corresponding block 464 shown in FIG. 13, the value of colZerlFlag indicates a “non-still image”. In this case, the value of colZerlFlag is 0 which is a value of a judgment indicator indicating a tendency of coding a current block 462 using field coding. Accordingly, the field or frame judging unit 404 judges that field coding is performed.

FIG. 14 is a flowchart indicating a method for judging one of field coding and frame coding to be performed on a P-picture on a per block basis in Embodiment 3 shown in FIG. 11.

First, the field or frame judging unit 404 calculates, from a reference picture, a block corresponding to a current block to be coded (S41).

Next, the field or frame judging unit 404 reads colZeroFlag defined for the corresponding block from the flag storage memory (S42).

Next, the field or frame judging unit 404 judges whether or not the value of colZeroFlag is 0 (S43).

When the value of colZeroFlag is 0 (Yes in S43), the field or frame judging unit 404 determines that field coding in field structure is performed (S44).

On the other hand, when the value of colZeroFlag is not 0 (No in S43), the field or frame judging unit 404 determines that frame coding in frame structure is performed (S45).

The above-described description has been given of field coding and frame coding performed on a P-picture in Embodiment 3, but the same coding may be performed on a B-picture.

In the case of a B-picture, the image coding apparatus 400 in Embodiment 3 shown in FIG. 11 can obtain colZeroFlag which is the judgment indicator defined for the corresponding block. Since a B-picture refers to two reference pictures, the image coding apparatus 400 obtains the value of colZeroFlag of each of the corresponding blocks included in the respective reference pictures, and judges one of field coding and frame coding to be performed, based on these two values. A description is given with reference to the drawings.

FIG. 15 is a conceptual diagram showing a judgment method in the case where each of two values of colZeroFlag indicates a still image in Embodiment 3.

A current frame 551 is an image corresponding to the input video signal 401 and a current image to be coded.

The current block 552 is a block included in the current frame 551, and is a current block to be coded.

A first reference picture 553 is a picture which is referred to in the coding of the current frame 551, and precedes the current frame 551 in display order.

The first corresponding block 554 is a block which is included in the first reference picture 553, and corresponds to the current block 552 which is a current block to be coded. For the first corresponding block 554, colZeroFlag indicating a “still image” is defined. In this case, the value of colZerlFlag is 1 which is a value of a judgment indicator indicating a tendency of coding a current block 552 using frame coding.

The second reference picture 555 is a picture which is referred to in the coding of the current frame 551, and succeeds the current frame 551 in display order.

The second corresponding block 556 is a block which is included in the second reference picture 555, and corresponds to the current block 552 which is the current block to be coded. For the second corresponding block 556, colZeroFlag indicating a “still image” is defined. In this case, the value of colZerlFlag is 1 which is a value of a judgment indicator indicating a tendency of coding a current block 552 using frame coding.

In this case, since both the values of two colZeroFlag are 1 indicating a tendency of coding the current block 552 in frame coding, the field or frame judging unit 404 judges that the current block 552 is coded in frame coding.

FIG. 16 is a conceptual diagram showing a judgment method in the case where each of two values of colZeroFlag indicates a non-still image in Embodiment 3.

A current frame 561 is an image corresponding to the input video signal 401 and a current image to be coded.

The current block 562 is a block included in the current frame 561, and is a current block to be coded.

A first reference picture 563 is a picture which is referred to in the coding of the current frame 561, and precedes the current frame 561 in display order.

The first corresponding block 564 is a block which is included in the first reference picture 563, and corresponds to the current block 562 which is a current block to be coded. For the first corresponding block 564, colZeroFlag indicating a “non-still image” is defined. In this case, the value of colZerlFlag is 0 which is a value of a judgment indicator indicating a tendency of coding a current block 562 using field coding.

The second reference picture 565 is a picture which is referred to in the coding of the current frame 561, and succeeds the current frame 561 in display order.

The second corresponding block 566 is a block which is included in the second reference picture 565, and corresponds to the current block 562 which is the current block to be coded. For the second corresponding block 566, colZeroFlag indicating a “non-still image” is defined. In this case, the value of colZerlFlag is 0 which is a value of a judgment indicator indicating a tendency of coding a current block 562 using field coding.

In this case, since both the values of two colZeroFlag are 0 indicating a tendency of coding the current block 562 in field coding, the field or frame judging unit 404 judges that the current block 562 is coded in field coding.

FIG. 17 is a conceptual diagram showing a judgment method in the case where two values of colZeroFlag indicate a still image and a non-still image respectively in Embodiment 3.

A current frame 571 is an image corresponding to the input video signal 401, and is a current image to be coded.

The current block 572 is a block included in the current frame 571, and is a current block to be coded.

A first reference picture 573 is a picture which is referred to in the coding of the current frame 571, and precedes the current frame 571 in display order.

The first corresponding block 574 is a block which is included in the first reference picture 573, and corresponds to the current block 572 which is a current block to be coded. For the first corresponding block 574, colZeroFlag indicating a “non-still image” is defined. In this case, the value of colZerlFlag is 0 which is a value of a judgment indicator indicating a tendency of coding a current block 572 using field coding.

The second reference picture 575 is a picture which is referred to in the coding of the current frame 571, and succeeds the current frame 571 in display order.

The second corresponding block 576 is a block which is included in the second reference picture 575, and corresponds to the current block 572 which is the current block to be coded. For the second corresponding block 576, colZeroFlag indicating a “still image” is defined. In this case, the value of colZerlFlag is 1 which is a value of a judgment indicator indicating a tendency of coding a current block 572 using frame coding.

In other words, among the values of two colZeroFlag, one of the values is 0 indicating the tendency of coding the current block 572 in field coding, and the other one is 1 indicating the tendency of coding the current block 572 in frame coding.

In this case, the field or frame judging unit 404 compares time (T1) in the first reference picture 573 and the current frame 571 and time (T2) in the second reference picture 575 and the current frame 571, and makes a judgment by prioritizing the value of colZeroFlag obtained from either the corresponding block 574 or the corresponding block 576 included in the picture which temporally closer to the current frame 571.

FIG. 18 is a flowchart indicating a method for judging whether field coding or frame coding is performed on a B-picture on a per block basis in Embodiment 3.

First, the field or frame judging unit 404 calculates, from the first reference picture, a first corresponding block which corresponds to a current block to be coded (S51). This is the same as in the process (S12) shown in FIG. 4 in Embodiment 1.

Next, the field or frame judging unit 404 reads colZeroFlag defined for the corresponding block from the flag storage memory 423 (S52). This is the same as in the process (S42) shown in FIG. 14 in Embodiment 1.

Next, the field or frame judging unit 404 calculates, from the second reference picture, a second corresponding block which corresponds to a current block to be coded (S53). This is the same as in the process (S34) shown in FIG. 6 in Embodiment 1.

Next, the field or frame judging unit 404 reads colZeroFlag defined for the corresponding block from the flag storage memory 423 (S54).

Next, the field or frame judging unit 404 judges whether or not the read values of two colZeroFlag match each other (S55).

When these values of colZeroFlag match (Yes in S55), the field or frame judging unit 404 performs the next processing (S57) using the values of colZeroFlag.

On the other hand, when these values of colZeroFlag does not match (No in S55), the field or frame judging unit 404 performs the next processing (S57) using the value of colZeroFlag obtained from the reference picture which is temporally closer to the current frame (S56).

Next, the field or frame judging unit 404 judges whether or not the value of colZeroFlag is 0 (S57).

When the value of colZeroFlag is 0 (Yes in S57), the field or frame judging unit 404 determines that field coding in field structure is performed (S58).

On the other hand, when the value of colZeroFlag is not 0 (No in S57), the field or frame judging unit 404 determines that frame coding in frame structure is performed (S59).

### (Other Variations)

The present invention has been described based on the aforementioned Embodiments, but it is to be noted that the present invention is not limited to these Embodiments as a matter of course. Exemplary implementations described below are also included in the present invention.

Specific examples of the respective devices include a microprocessor, a ROM, a RAM, a hard disc unit, a display unit, keyboards, a mouse, which configure a computer system. In the RAM or hard disc unit, a computer program is stored. By means that the microprocessor operates according to the computer program, the respective devices achieve their functions. Here, with an aim to achieve the predetermined functions, the computer program is configured with a combination of plural instruction codes each indicating a directive to the computer.

Some or all of the structural elements which constitute a corresponding one of the devices may be configured in a single system LSI (Large Scale Integration). A system LSI is a super-multi-functional LSI configured by integrating plural structural units on a single chip. A specific example of this is a computer system configured to include a microprocessor, a ROM, a RAM, and the like. In the RAM, a computer program is stored. By means that the microprocessor operates according to the computer program, the system LSI achieves its functions.

Some or all of the structural elements which constitute a corresponding one of the devices may be configured with an IC card or an independent module which is attachable/detachable to/from each of the devices. Each of the IC card or the module is a computer system configured with a microprocessor, a ROM, a RAM, and the like. The IC card or the module may include the aforementioned super-multi-functional LSI. By means that the microprocessor operates according to the computer program, the IC card or the module achieves its functions. This IC card or module may be tamper-resistant.

The present invention may be implemented as the above-described methods. In addition, each of these methods may be a computer program which is executed by a computer, and may be a digital signal representing the computer program.

In addition, the present invention may be the computer program or the digital signal recorded on a computer-readable recording medium such as a flexible disc, a hard disc, a CD-ROM, an MO, a DVD, a DVD-ROM, a DVD-RAM, a BD (Blu-ray Disc), or a semiconductor memory. In addition, the present invention may be the digital signal recorded on the recording medium.

In addition, the present invention may be the computer program or the digital signal which is transmitted via an electrical communication circuit, a wireless or wired communication circuit, a network represented by the Internet, data broadcasting, and the like.

The above-described Embodiments and Variations may be combined in any manner.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

As described above, the coding apparatus and decoding apparatus in the present invention is applicable to mobile telephones, DVD devices, the next-generation DVD devices (such as Blu-ray Discs and HD-DVDs), digital TVs and the like each of which encodes an image to generate a coded sequence.

What is claimed is:

1. A method for judging between frame coding and field coding, in moving picture coding performed while switching between frame coding and field coding on a per block basis, said method comprising:
specifying, in a first reference picture, a first corresponding block which corresponds to a current block to be coded, the first reference picture being referred to in coding of the current block to be coded;
obtaining a first judgment indicator indicating appropriateness of frame coding or field coding for the current block to be coded, based on the first corresponding block specified in said specifying; and
judging one of frame coding and field coding to be appropriate as a coding method for the current block to be coded, according to the first judgment indicator obtained in said obtaining.

2. The method for judging between frame coding and field coding according to claim 1,
wherein, in said specifying, a block co-located with the current block to be coded in a picture is specified as the first corresponding block.

3. The method for judging between frame coding and field coding according to claim 1,
wherein, in said obtaining, a value indicating an amount of difference in pixel values of pixels in a vertical direction of the first corresponding block is obtained as the first judgment indicator.

4. The method for judging between frame coding and field coding according to claim 1,
wherein, in said obtaining, a value is obtained as the first judgment indicator by calculation based on a first difference and a second difference, the first difference being between pixel values of two pixels adjacent to each other in a vertical direction of the first corresponding block, and the second difference being between pixel values of two pixels located at every other position among pixels arranged consecutively in the vertical direction of the first corresponding block; and
in said judging, frame coding is judged to be appropriate when the value which is the first judgment indicator indicates that the first difference is smaller than the second difference, the first difference being between the pixel values of the two pixels adjacent to each other in the vertical direction of the first corresponding block, and the second difference being between the pixel values of the two pixels located at every other position among pixels arranged consecutively in the vertical direction of the first corresponding block.

5. The method for judging between frame coding and field coding according to claim 1,
wherein, in said obtaining, a flag indicating whether or not an image of the first corresponding block is a still image is obtained as the first judgment indicator, and
in said judging, frame coding is judged to be appropriate when the flag obtained in said obtaining indicates that the image is the still image.

6. The method for judging between frame coding and field coding according to claim 1, said method further comprising
obtaining a second judgment indicator indicating appropriateness of frame coding or field coding for the current block to be coded, based on an image of the current block to be coded,
wherein, in said judging, one of frame coding and field coding is judged to be appropriate as the coding method for the current block to be coded, according to the first judgment indicator and the second judgment indicator.

7. The method for judging between frame coding and field coding according to claim 6,
wherein, in said obtaining a second judgment indicator, the second judgment indicator is obtained by performing, on the current block to be coded, same processing as processing performed on the first corresponding block when the first judgment indicator is obtained in said obtaining a first judgment indicator.

8. The method for judging between frame coding and field coding according to claim 6, said method further comprising
storing the second judgment indicator onto a storage area in association with the current block to be coded, said second judgment indicator being obtained based on the current block in said obtaining a second judgment indicator,
wherein, in said specifying, the first corresponding block is specified from among blocks associated with second judgment indicators stored respectively in the storage area, and
in said obtaining a first judgment indicator, the second judgment indicator corresponding to the first corresponding block is obtained as the first judgment indicator from among the second judgment indicators stored in the storage area.

9. The method for judging between frame coding and field coding according to claim 6,
wherein, in said judging, one of frame coding and field coding is judged to be appropriate as the coding method for the current block to be coded, based on a result of weighted calculation of the first judgment indicator and the second judgment indicator.

10. The method for judging between frame coding and field coding according to claim 1, said method further comprising:
specifying, in a second reference picture, a second corresponding block which corresponds to the current block to be coded, the second reference picture being referred to in the coding of the current block to be coded; and
obtaining a third judgment indicator indicating appropriateness of frame coding or field coding for the current block to be coded, based on the second corresponding block specified in said specifying,
wherein, in said judging, one of frame coding and field coding is judged to be appropriate as the coding method for the current block to be coded, according to the first judgment indicator and the third judgment indicator.

11. The method for judging between frame coding and field coding according to claim 10,
wherein, in said judging, one of frame coding and field coding is judged to be appropriate as the coding method for the current block to be coded, based on a result of weighted calculation in which the first judgment indicator is added with a weight greater than a weight added to the third judgment indicator when the first reference picture is temporally close to a picture including the current block to be coded compared to the second reference picture.

12. The method for judging between frame coding and field coding according to claim 10,
wherein, in said obtaining a first judgment indicator, the first flag is obtained as the first judgment indicator, the first flag indicating whether or not an image of the first corresponding block is a still image,
in said obtaining a third judgment indicator, the second flag is obtained as the third judgment indicator, the second flag indicating whether or not an image of the second corresponding block is a still image, and
in said judging, (i) frame coding is judged to be appropriate when the first reference picture is temporally close to a picture including the current block to be coded compared to the second reference picture, and the first flag indicates that the image is the still image, and (ii) field coding is judged to be appropriate when the first reference picture is temporally close to a picture including the current block to be coded compared to the second reference picture, and the first flag indicates that the image is not the still image.

13. The method for judging between frame coding and field coding according to claim 10, said method further comprising
obtaining a second judgment indicator indicating appropriateness of frame coding or field coding for the current block to be coded, based on the image of the current block to be coded,
wherein, in said judging, one of frame coding and field coding is judged to be appropriate as the coding method for the current block to be coded, according to the first judgment indicator, the second judgment indicator, and the third judgment indicator.

14. The method for judging between frame coding and field coding according to claim 13,
wherein, in said judging, when the first judgment indicator and the second judgment indicator indicate same appropriateness, a coding method is judged to be appropriate based on the appropriateness indicated by the first judgment indicator or the second judgment indicator and without using the third judgment indicator.

15. The method for judging between frame coding and field coding according to claim 13,
wherein, in said judging, one of frame coding and field coding is judged to be appropriate as the coding method for the current block to be coded, based on a result of weighted calculation of the first judgment indicator, the second judgment indicator, and the third judgment indicator.

16. The method for judging between frame coding and field coding according to claim 13,
wherein, in said obtaining a first judgment indicator, a numerical value is obtained as the first judgment indicator, the numerical value indicating a magnitude of a difference obtained by calculation based on a first difference and a second difference, the first difference being between pixel values of two pixels adjacent to each other in a vertical direction of the first corresponding block, and the second difference being between pixel values of two pixels located at every other position among pixels arranged consecutively in the vertical direction of the first corresponding block,
in said obtaining a second judgment indicator, a numerical value is obtained as the second judgment indicator, the numerical value indicating a magnitude of a difference obtained by calculation based on a first difference and a second difference, the first difference being between pixel values of two pixels adjacent to each other in a vertical direction of the current block to be coded, and the second difference being between pixel values of two pixels located at every other position among pixels arranged consecutively in the vertical direction of the current block to be coded,
in said obtaining a third judgment indicator, a numerical value is obtained as the third judgment indicator, the numerical value indicating a magnitude of a difference obtained by calculation based on a first difference and a second difference, the first difference being between pixel values of two pixels adjacent to each other in a vertical direction of the second corresponding block, and the second difference being between pixel values of two pixels located at every other position among pixels arranged consecutively in the vertical direction of the second corresponding block, and
in said judging, frame coding is judged to be appropriate when a numerical value for indicating a sum of the first judgment indicator, the second judgment indicator, and the third judgment indicator indicates that a first sum of differences is smaller than a second sum of differences, the first sum of differences being obtained based on the differences between the pixel values of pairs of the two pixels adjacent to each other in the vertical directions of the first corresponding block, the current block to be coded, and the second corresponding block, and the second sum of differences being obtained based on the differences between the pixel values of pairs of the two pixels located at every other position among the pixels arranged consecutively in the vertical directions of the first corresponding block, the current block to be coded, and the second corresponding block.

17. A method for coding an image while switching between frame coding and field coding on a per block basis, said image coding method including the method for judging between frame coding and field coding according to claim 1.

18. An image coding apparatus which performs coding while switching between frame coding and field coding on a per block basis, said apparatus comprising:
a first corresponding block specifying unit configured to specify, in a first reference picture, a first corresponding block which lo corresponds to a current block to be coded, the first reference picture being referred to in coding of the current block to be coded;
a first judgment indicator obtaining unit configured to obtain a first judgment indicator indicating appropriateness of frame coding or field coding for the current block to be coded, based on the first corresponding block specified by said first corresponding block specifying unit; and
a judging unit configured to judge one of frame coding and field coding to be appropriate as a coding method for the current block to be coded, according to the first judgment indicator obtained by said first judgment indicator obtaining unit.

19. A program causing a computer to execute the method for judging between frame coding and field coding according to claim 1.
